(19) United States
(12) Patent Application Publication
(10) Pub. No.: US 2026/0043379 A1
(43) Pub. Date: Feb. 12, 2026

(54) Transfer Line Chilldown Heat Transfer of Cryogenic Propellant in Microgravity using Low-thermally Conductive Coating and Pulse Flow for Space Exploration

(71) Applicants: University of Florida Research Foundation, Inc., Gainesville, FL (US); United States of America As Represented By The Administrator of NASA, Washington, DC (US)

(72) Inventors: Jacob N. CHUNG, Gainesville, FL (US); Jun DONG, Gainesville, FL (US); Jason W. HARTWIG, Cleveland, OH (US); Bo-Han HUANG, Gainesville, FL (US); Hao WANG, Gainesville, FL (US)

(21) Appl. No.: 18/742,196

(22) Filed: Jun. 13, 2024

Related U.S. Application Data
(60) Provisional application No. 63/521,274, filed on Jun. 15, 2023.

(51) Int. Cl. F02K 9/64; B64G 1/00; F02K 9/60; F17C 7/02

(52) U.S. Cl. CPC F02K 9/64; B64G 1/00; F02K 9/605; F17C 7/02; F17C 2205/0323; F17C 2205/0352; F17C 2221/011; F17C 2221/08; F17C 2223/0161; F17C 2250/0439; F17C 2250/0636; F17C 2265/066; F17C 2270/0194; F17C 2270/0197

(57) ABSTRACT

The enabling of in-space cryogenic engines and cryogenic fuel depots for future space exploration missions begins with development of cryogenic fluid management systems upstream in the propellant feed system. Before single-phase liquid can flow to the engine or customer spacecraft receiver tank, the connecting transfer line can be chilled down to cryogenic temperatures. In some examples, a method to quench the line is to use the cold propellant itself. When a cryogenic fluid is introduced into a warm transfer system, two-phase flow quenching ensues. Due to the projected cost of space exploration, it is desired to perform this chilldown process using the least amount of propellant. The embodiments include enhancements that reduce the amount of propellant consumed during chilldown while in a microgravity environment. Experiments were performed to examine the effects of using low thermally conductive coatings and pulse flow on the chilldown process.

### CROSS-REFERENCE TO RELATED PATENT APPLICATIONS

This application claims the benefit of and priority to U.S. Provisional Patent Application 63/521,274 entitled “Transfer Line Chilldown Heat Transfer of Cryogenic Propellant In Microgravity Using Low Thermally Conductive Coatings and Pulse Flow for Space Exploration,” and filed on Jun. 15, 2023, which is incorporated herein by reference in its entirety.

### STATEMENT REGARDING FEDERALLY SPONSORED RESEARCH OR DEVELOPMENT

This invention was made with government support under Grant No. NNX16AP68G, awarded by NASA Armstrong Flight Research Center; and Grant No. 80NSSC18K1741, awarded by NASA Glenn Research Center. The government has certain rights in the invention.

### BACKGROUND

One of National Aeronautics and Space Administration (NASA)'s biggest challenges will be extending human space exploration from low earth orbit to high earth orbit, then to the Moon, Mars, and other asteroids. One aspect of space exploration is the effective, sufficient, and reliable supply of cryogenic propellant fluids. The lower-earth-orbiting propellant space depots and the human orbital transfer spacecraft to the moon and Mars may need to depend on the high thrust and high efficiency of liquid cryogenic chemical propulsion or nuclear thermal propulsion.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a table of a flight test matrix, according to one embodiment described herein.

FIGS. 2A-2C illustrate various graphs of flight data, according to one embodiment described herein.

FIGS. 3A-3D illustrate various graphs on the effects of Teflon coating thickness in microgravity, according to one embodiment described herein.

FIGS. 4A-4E illustrate various graphs on the effects of pulse flow on a bare tube in microgravity, according to one embodiment described herein.

FIGS. 5A and 5B illustrate various graphs on the combined effect of coatings and pulse flow in microgravity, according to one embodiment described herein.

FIGS. 6A-6E illustrates various views of an experimental design, according to one embodiment described herein.

FIG. 7 illustrates a graph of performance gains on pulse flow and coated tube in microgravity, according to one embodiment described herein.

### SUMMARY

Embodiments of the present disclosure are related to a transfer line chilldown heat transfer of cryogenic propellant in microgravity using low-thermally conductive coatings and pulse flow for space exploration.

According to one embodiment, among others, a cryogenic propellant transfer apparatus for a chilldown process in microgravity. The apparatus comprises a metallic pipe for transferring cryogenic propellant fuel from a fuel storage tank to a nozzle of a combustion chamber for a rocket engine and an inner surface of the metallic pipe comprises a low thermal conductivity thin-filmed coating layer. The low conductivity thin-filmed coating layer can have a thermal conductivity in a range of 0.1 Watt per meter-Kelvin to 1.0 Watt per meter-Kelvin. The apparatus can further include a feed system that is configured to use a pulse flow for transferring the cryogenic propellent fuel from the fuel storage tank to the nozzle of the combustion chamber for the rocket engine through the metallic pipe.

According to one embodiment, among others, a method comprising determining, via a temperature sensor, a temperature of a metallic transfer pipe for a chilldown process, the metallic transfer pipe being configured to transfer liquid propellant from a propellant storage to a nozzle of a combustion chamber of a rocket engine. The transfer pipe comprises a low conductivity thin-filmed coating layer as an inner surface. The low conductivity thin-filmed coating layer has a thermal conductivity in a range of 0.1 Watt per meter-Kelvin to 1.0 Watt per meter-Kelvin. The method further includes pulse flowing, via a duty cycle the liquid propellent from the propellant storage to the nozzle of the combustion chamber for the rocket engine through metallic transfer pipe and terminating the pulse flow and the chilldown process upon the temperature of the metallic transfer pipe meeting a liquid propellant temperature.

### DETAILED DESCRIPTION

The enabling of in-space cryogenic engines and cryogenic fuel depots for future manned and robotic space exploration missions begins with technology development of advanced cryogenic fluid management (CFM) systems upstream in the propellant feed system. Cryogenic propellants offer significantly higher performance relative to storable counterparts, such as hydrazine, because of a higher specific impulse and higher energy density. Further, safety and environmental concerns over the use of toxic storable propellants have led to the ongoing examination of more “green” propellants such as liquid methane as alternate fuel sources. Aside from nuclear thermal propulsion systems, no other known pure chemical propulsion system propellant combination can deliver a higher Specific Impulse (HSP) than liquid hydrogen/liquid oxygen. However, there are challenging aspects when working with cryogens due to inherent thermo-physical properties. Particularly for the current work, the low normal boiling point (NBP), low surface tension, and high susceptibility to parasitic heat leak leads to unwanted boiling and two-phase flow during propellant transfer.

The present disclosure describes that just by coating the pipe inner surface with low-thermal conductivity thin-films, the quenching efficiency can be increased up to 176% over that of the traditional bare-surface pipe with continuous flow for the thermal management process of chilling down the transfer pipe in microgravity, which can be defined as about or equal to “zero gravity” (0g). Across a wide range of quenching flow rates, the present disclosure includes experimental results that show the combination of flow pulsing and tube coating significantly enhances performance in microgravity, with a reduction in consumed mass up to 75% relative to continuous flow for a bare transfer line.

Cryogenic fuel depots (e.g., fuel storage tanks) can be defined as an Earth-orbiting propellant storage vessel that would house cryogenic propellant to allow spacecraft to refuel, have four stages: (1) acquisition of the storage tank liquid, (2) chilldown of the connecting transfer line hardware, (3) chilldown of the receiver tank, and (4) fill of the receiver tank, all in the microgravity of space; the present disclosure describes at least the second stage, chilldown of the transfer line. Meanwhile, cryogenic engines also require acquisition of the storage tank liquid and chilldown of the transfer line. Cryogenic fuel depots can require very high liquid volume fill fractions in the customer receiver tank, and most in-space engines require single-phase liquid up to the injectors. Therefore, without advanced CFM technologies upstream in the feed system and storage tank, vapor ingestion is inevitable, which can lead to combustion instabilities within the engine. Further, exacerbating the transfer process in microgravity is the unknown location of the liquid and vapor phases in the tank as well as reduced heat transfer. Before single-phase liquid can flow to the engine or customer spacecraft receiver tank, the connecting transfer line must first be chilled down to cryogenic temperatures. Chilldown, or quenching, is defined as the transient process of cooling hardware down to cryogenic temperatures so that vapor-free liquid can eventually flow between two points of interest. The most direct and simplest method to quench the line is to use the cold propellant itself. When a cryogenic fluid is initially transferred through a system, the tube walls and hardware (e.g., valves) undergo a transient chilldown prior to reaching a steady state of operation, where one or more temperature sensors (e.g. thermocouples) can be used to measure the temperature of one or more locations of the system until a liquid propellant temperature is reached. Chilldown thus involves unsteady two-phase heat and mass transfer and flow boiling. While boiling is a highly efficient mode of heat transfer, previous work has shown this efficiency is significantly lowered in reduced gravity, both for room temperature fluids as well as cryogens. Due to the projected cost of launching and storing cryogens in space, it is desired to perform this chilldown process using the least amount of propellant as possible, especially given the drive towards reusable systems and thus multiple transfers. Numerous cryogenic flow boiling quenching experiments have previously been conducted on bare tubes. It has been investigated that the effect of mass flux, inlet state, pressure, and flow direction on cryogenic tube chilldown, predominately using liquid nitrogen (LN2) and liquid hydrogen (LH2). For all cryogens, the chilldown process is highly dominated by the film boiling regime for bare tubes (for quantum fluids such as hydrogen and helium, there are additional factors at play).

When a cryogen is introduced into a warm tube, especially at high mass flux and low inlet equilibrium quality, a vapor film blanket surrounds the liquid core which acts as an insulator that inhibits heat transfer between cold liquid and warm tube. At lower mass flux and saturated inlet states, dryout can occur over a longer distance along the tube as in the case of traditional fluids. Film boiling heat transfer is a highly inefficient process relative to transition and nucleate boiling. In most instances, film boiling can persist for >85% of the total time needed to chill the tube down to the saturation temperature of the cryogen. Once the Leidenfrost point is reached, chilldown proceeds into transition boiling, nucleate boiling, and then single-phase liquid convective flow. In microgravity, this poor heat transfer is exacerbated by the lack of buoyancy force; cryogenic film boiling heat transfer was shown to be 25% lower at low to modest Re flows. At very high Re, inertial forces can overcome gravitational forces such that gravity no longer affects flow boiling (although this has not been demonstrated yet for cryogens).

To overcome this hurdle in poor performance, low thermally conductive materials applied to the inner tube walls and the effect of such coatings on the chilldown process have been investigated. The coating acts as an insulator between the cold propellant and warm wall, resulting in an inner wall surface temperature that reaches the Leidenfrost point without cooling the entire tube mass. Recent experiments confirmed that a Teflon™ coated tube could reduce chilldown times up to 75% over an uncoated stainless steel (SS) tube using LN2. The effect of the Teflon™ coating thickness on chilldown performance have been investigated, and the investigations showed that thicker coatings led to faster chilldown times. However, as the coating thickness increased further there was an apparent point of diminishing returns because the chilldown curves (wall temperature versus time) converged at the highest tested thicknesses. Coated tubes offer hope to combat the intrinsically poor film boiling heat transfer in microgravity.

A second way to enhance poor chilldown performance is to use pulse flow. Demonstrated using both LH2 and LN2, in pulse flow, the inlet valve is cyclically opened and closed with a specified duty cycle (DC) and pulse width until the desired degree of chilldown is reached. The advantage of pulse flow is lower mass consumption over traditional continuous flow due to more efficient usage of latent and sensible energy of the fluid, with the disadvantage being potential valve fatigue and/or failure and added complexity in operation.

The present disclosure includes an assessment of two new performance enhancements that reduce the amount of propellant consumed during chilldown while in a microgravity environment, and the present disclosure asserts that the mass savings holds in microgravity. Twenty-eight LN2 transfer line chilldown experiments were performed onboard a parabolic flight that simulated space microgravity conditions to examine the independent as well as combined performance gains of using low thermally conductive coatings and pulse flow on the chilldown process. This is the first report of pulse flow and the combined effect of pulse flow with a coated tube in a microgravity environment.

### Results and Discussion

### Test Matrix

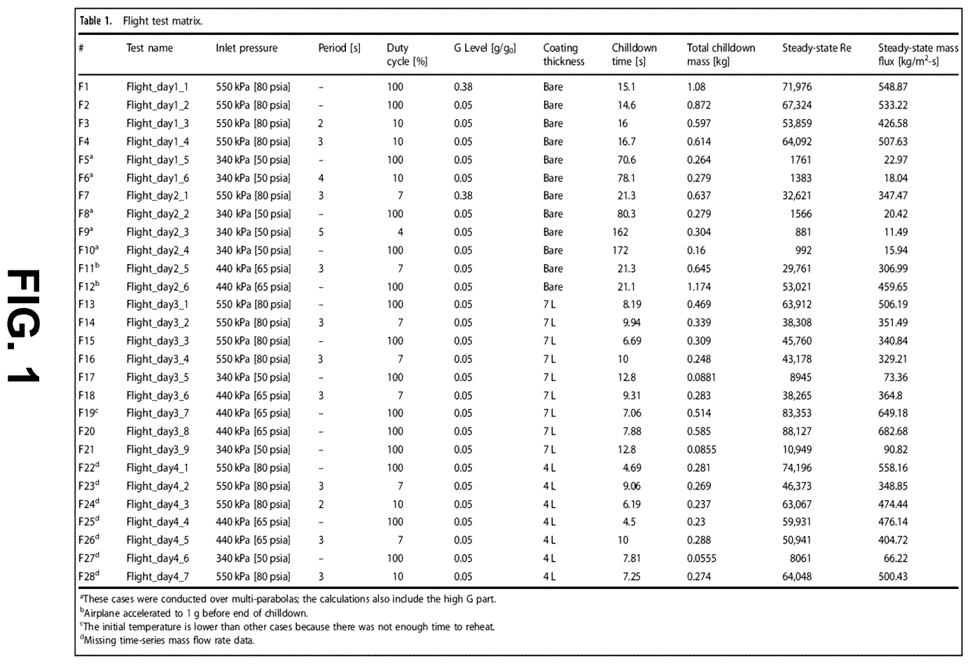

Table 1 of FIG. 1. lists the complete flight test matrix. Ground tests were performed at the University of Florida, while flight tests were conducted during the low-gravity portion of the classic parabolic trajectory followed by the flight provider Zero-G. Pressure is the measured pressure at the inlet to the test section, time-averaged over the test duration. Period is the sum of valve “on” and “off” time for a pulse flow test cycle. The duty cycle is the ratio of the valve “on” time to the period. For example, with a period of 3 s and a duty cycle of 10%, the valve is on 0.3 s and off for 2.7 s. G level is the gravity level as read by accelerometers attached to the experimental rig while on the flight. Note that a few of the flight tests were conducted at a g-level higher than nominal; these were deemed “Martian gravity tests”. Coating thickness in number of layers, “L”, is described in the “Methods” section.

Chilldown time was determined as follows: In practice, the most stringent chilldown criteria would be determined from a measured stream temperature downstream of the test section reading lower than the saturation temperature based on the downstream pressure; however, this measurement was not available for the current tests. Based on boiling heat transfer theory, nucleate boiling would end when the inner surface temperature drops below that of the onset-of-nucleate boiling (ONB). As a result, the wall heat flux would switch from higher boiling heat flux to much lower single-phase convective heat flux that would reflect a change on the outer wall surface temperature gradient with time. A computed inner wall temperature could also not be used to determine end of chilldown; while the inverse conduction method of Burggraf can be used to determine inner wall temperature for bare tubes, due to the unknown thermal contact resistances between the coated layer and tube inner wall as well as among adjacent coated layers, inner wall temperature could not be determined for coated tubes. Therefore, outer wall temperature data (of the metallic pipe for transferring the cryogenic propellant fuel) had to be used to determine end of chilldown. Three chilldown criteria were explored: (1) the averaged exit outer wall temperature was compared to the liquid saturation temperature (based on local downstream pressure), (2) the first derivative of outer wall temperature (with respect to time) reaching and remaining near 0 K/s (due to minimal convective heat transfer between single-phase liquid and tube), and (3) a peak value in the second derivative of outer wall temperature (with respect to time) which would indicate the slope change in the chilldown curve occurring at onset of nucleate boiling (ONB). The first method was found to be unreliable due to inaccurate chilldown time estimations attributed to the significant difference between inner and outer wall temperature at higher layers of coating. The third method also yielded inaccurate chilldown time estimations attributed to the absence of a true global maxima in the second derivative at higher layers of coating. Therefore, the second method using the first derivative (typically using test section averaged temperature), slightly conservative but consistent across all scenarios, was used to determine the end of chilldown in all test cases.

Chilldown mass was the total consumed LN2 mass at the end of chilldown as read by the flow meter downstream of the test section:

$${m}_{LN 2} = {\int }_{0}^{{t}_{end}} \dot{m} dt \qquad ( 1 )$$

where t_{end} is the end of chilldown time and \dot{m}(t) is the time dependent LN₂ mass flow rate measured by the gas flow meter. Steady state Reynolds (Re) number (defined at the end of chilldown when single phase liquid flow is established) and mass flux were evaluated using inner diameter and saturation conditions based on the measured test section pressure:

$$Re = \frac{4 \dot{m}}{π D μ} \qquad ( 2 )$$

For uncoated tubes, the method of Burgraff was used to determine inner wall temperature and transient radial heat conduction through the tube as follows:

$${q}_{w}^{″} = ρ {c}_{P} ( \frac{{r}_{\text{?}}^{2} - {r}_{o}^{2}}{2 {r}_{\text{?}}} ) \frac{{dT}_{\text{?}}}{dt} + \frac{{( ρ {c}_{P} )}^{2}}{k} ( \frac{{r}_{\text{?}}^{3}}{16} - \frac{{r}_{\text{?}}^{4}}{16 {r}_{\text{?}}} - \frac{{r}_{\text{?}}^{2} {r}_{\text{?}}}{4} ln ( \frac{{r}_{\text{?}}}{{\text{?}}_{o}} ) ) \frac{{d}^{2} {T}_{\text{?}}}{{dt}^{2}} + \frac{{( ρ {c}_{p} )}^{3}}{{k}^{2}} ( \frac{{r}_{\text{?}}^{5}}{384} - \frac{3 {r}_{o}^{4} {\text{?}}_{\text{?}}}{128} + \frac{3 {r}_{o}^{2} {r}_{\text{?}}^{3}}{128} - \frac{{\text{?}}_{\text{?}}^{\text{?}}}{384 {r}_{\text{?}}} - \frac{{\text{?}}_{o}^{2} {r}_{\text{?}}^{3}}{128} ln ( \frac{{\text{?}}_{\text{?}}}{{\text{?}}_{o}} ) - \frac{{\text{?}}_{o}^{4} {r}_{i}}{32} ln ( \frac{{\text{?}}_{\text{?}}}{{\text{?}}_{\text{?}}} ) ) - \frac{{d}^{3} {T}_{o}}{{dt}^{3}} \qquad ( 3 )$$

$$\text{?} \text{indicates text missing or illegible when filed}$$

where q″_{w} is the radial heat flux through the tube, ρ, C_{P}, and k are the tube density, specific heat, and thermal conductivity, respectively, rᵢ and rₒ are the inner and outer radii, and Tₒ is the outer wall temperature. Heat transfer coefficient was then computed as follows:

$${h}_{quench} = \frac{{q}_{w}^{″} + {q}_{axial}^{″} + \frac{{r}_{o}}{{r}_{i}} ( {q}_{rad}^{″} + {q}_{solidcond}^{″} + {q}_{gascond}^{″} )}{{T}_{i} - {T}_{sat}} \qquad ( 4 )$$

where q″ₐₓᵢₐₗ is the axial conduction along the tube; the terms in parenthesis are the radiation, solid conduction, and gaseous conduction parasitic heat leak terms, respectively, Tᵢ is the inner wall temperature which comes from Burgraff's method, and Tₛₐₜ is the saturation temperature based on the measured pressure. The method to calculate the different heat fluxes in Eq. 4 has been shown in other papers. Governing physics of chilldown

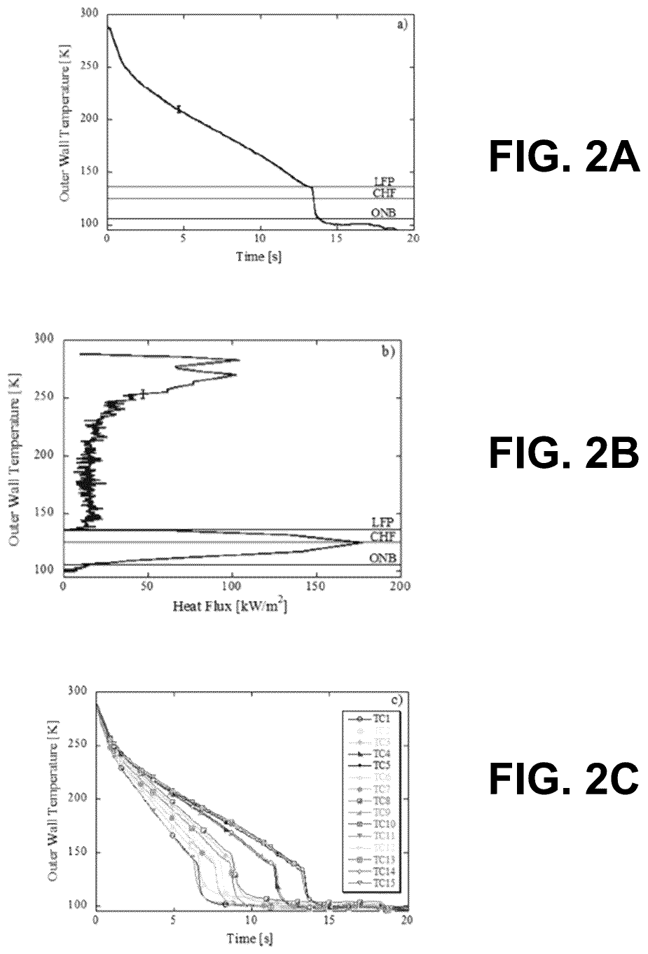

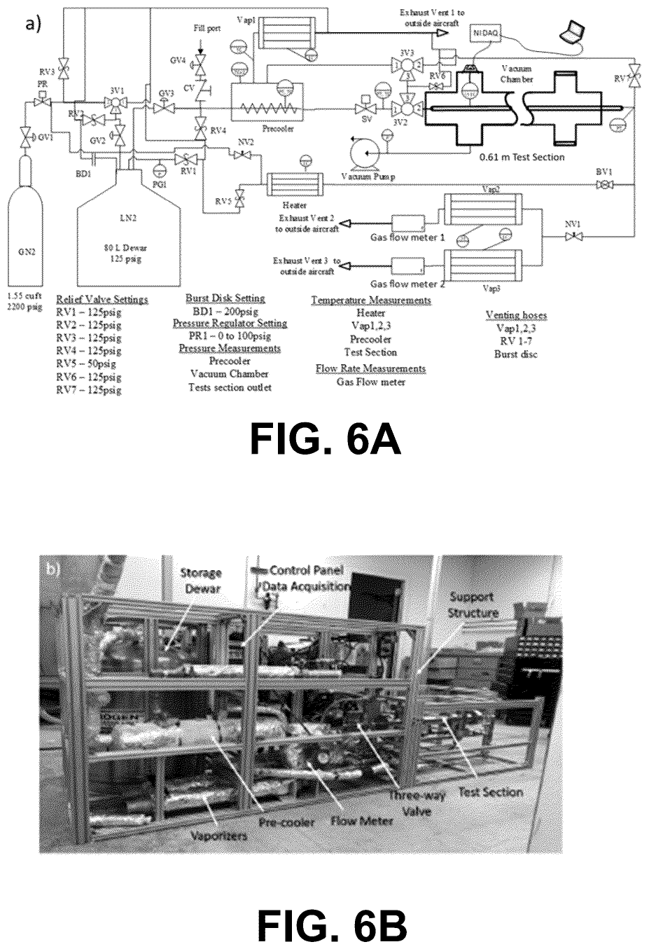

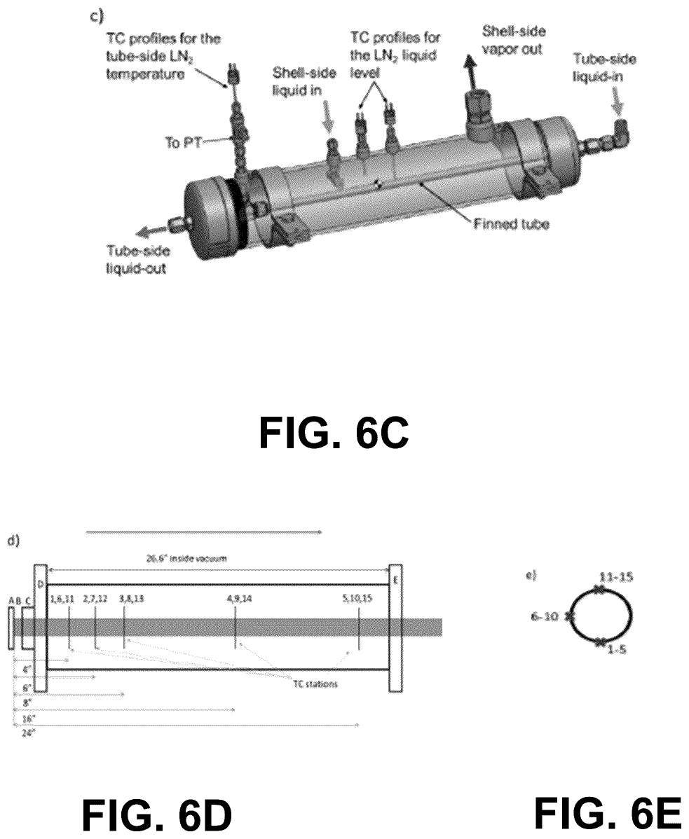

FIG. 2A shows the chilldown curve of averaged exit wall temperature (TC5, TC10, TC15) and FIG. 2B shows the boiling curve based on the averaged exit wall temperature in microgravity. Averaging was done by adding the temperatures and dividing by the number of sensors. FIG. 2C illustrates the chilldown curve of all thermocouples (TCs) placed on the tube outer wall according to FIG. 6D, 6E in the “Methods” section. Errors bars are plotted but barely discernable. Three boiling regimes, film boiling (FB), transition boiling (TB), and nucleate boiling (NB), and single phase convection are separated by three critical points, the Leidenfrost Point (LFP), Critical Heat Flux (CHF), and the onset of nucleate boiling (ONB). The chilldown curve begins in the film boiling regime where the cold liquid entering the warm tube experiences violent boiling. Depending on the local conditions, the flow will proceed into dispersed flow FB (high quality, low subcooling, low mass flux) or inverted annular FB (low quality, high subcooling, high mass flux). The high wall surface temperature causes the liquid to completely vaporize before reaching the surface resulting in an inner liquid core and outer annular vapor core. This vapor blanket along the wall insulates the warm pipe from the cold liquid, causing the temperature of the pipe to decrease, albeit slowly. FB is the least efficient quenching mechanism. As the transfer line chills down, the system approaches the LFP, or rewet temperature, where heat flux is at a minimum (during boiling). Heat transfer here is a minimum due to the inefficiency of heat transfer between cold vapor and wall. LFP is also characterized by the onset of a rapid drop in wall temperature. As shown in FIG. 2C, the LFP occurs at later times for TCs located farther downstream. This trend demonstrates the location of the quenching front as it propagates downstream as chilldown evolves. The flow then proceeds and passes quickly through TB, characterized by intermittent liquid contact along the walls. TB ends when liquid is in full contact with the walls at the point of CHF. Heat transfer is a maximum at CHF due to the highly efficient cooling process of boiling. Nucleate boiling follows, where heat is transferred by vapor bubbles formed in surface cavities that are swept away from the tube surface. Depending on the inlet conditions, NB can be liquid-convection dominate or nucleation-dominate. As the wall cools further, the tube inner surface approaches the ONB, characterized as the point at which the system evolves from nucleate two-phase cooling to single phase liquid convection and an obvious slope change in the chilldown curve. Vapor-free liquid marks the end of the chilldown test. The single-phase cooling causes the wall temperature to drop slowly to the liquid saturation temperature and then remain steady as heat transfer reduces to near zero. In microgravity, circumferential TCs at each station have almost identical chilldown behavior at any axial distance from the inlet; stratification effects normally seen for horizontal tubes in disappear, leading to axisymmetric flow patterns through the tube, and thus uniform chilldown circumferentially.

Bare Vs. Coated Tube in Microgravity, Continuous Flow

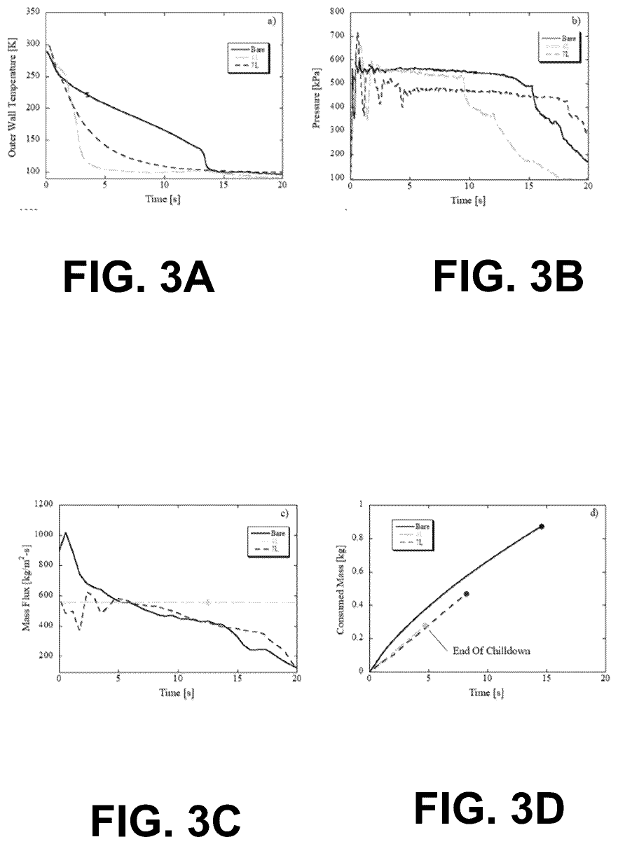

FIGS. 3A-D plot chilldown curves, exit pressure, mass flux, and total consumed liquid mass for bare, 4 L, and 7 L coated tubes for higher steady state Re (63,912-74,196). The initial fluctuations in pressure measurements in FIG. 3B are due to the transient nature of the flow at start of the test. Shortly after the transient start, downstream pressure measurements reach their steady-state value and remain there until at least the end of chilldown in all three cases. The mass flux of the 4 L coating case in FIG. 3C is a straight horizontal line because of missing timed mass flow rate data for that run; a linear correlation was developed between averaged inlet pressure and averaged mass flow rate for cases with available mass flow rate data that were run at 0.05 g level and were completed under one parabola. This linear correlation was then used to calculate an average mass flow rate for cases with missing mass flow rate data (but available inlet pressure data).

Trends are as follows: First, coating the inner wall of the tube drastically affects the chilldown behavior and leads to faster chilldown times. The low thermally conductive Teflon™ layer acts as an insulator between cold fluid and warm wall; the inner surface temperature chills down quickly without cooling the entire tube mass. The lower inner wall surface temperature earlier on means that the Leidenfrost point is reached faster such that the liquid can stay in contact with the tube for the heat transfer to be in TB and NB that reduces the poor heat transfer film boiling time; this is substantiated by the drastic slope change for 4 L and 7 L tube indicating the LFP is reached earlier on relative to the bare tube. Note that FIG. 3A plots outer wall temperature; the actual inner wall temperature for the coated tubes will be significantly lower since the coating restricts the heat transfer between inner and outer walls. Second, less mass is consumed for coated over bare tubes as substantiated in FIG. 3D; the 4 L and 7 L coated cases have 68 and 46% propellant mass savings over the bare tube, respectively.

Third, however, there is an apparent point of diminishing returns; this trend of improved chilldown performance upon addition of coating is reversed when the number of coating layers is increased from 4 to 7 because the chilldown time is faster for 4 L (4.7 s) compared to 7 L (8.2 s) case. Similarly, from 4 L to 7 L, the propellant mass savings and chilldown efficiency are reduced. This crossover in performance and possible existence of an optimal coating layer is explained by counteracting heat transfer mechanisms: (1) the low thermal conductivity of the coating layer facilitates the faster temperature drop of tube inner surface by restricting heat transfer between inner surface and bulk of the metal tube and (2) the low thermal conductivity coating also creates a thermal resistance that restricts the heat conduction between bulk of the tube and cooling fluid. With these contrasting mechanisms at play, the thickness of the coating must be such that it is thick enough to quickly lower the tube inner surface temperature while being thin enough to facilitate fast wall chilldown. However, the presence of the coating accelerates chilldown as evident in any comparison between bare and coated tube at similar thermodynamic conditions.

### Continuous Versus Pulse Flow in Microgravity, Bare Tube

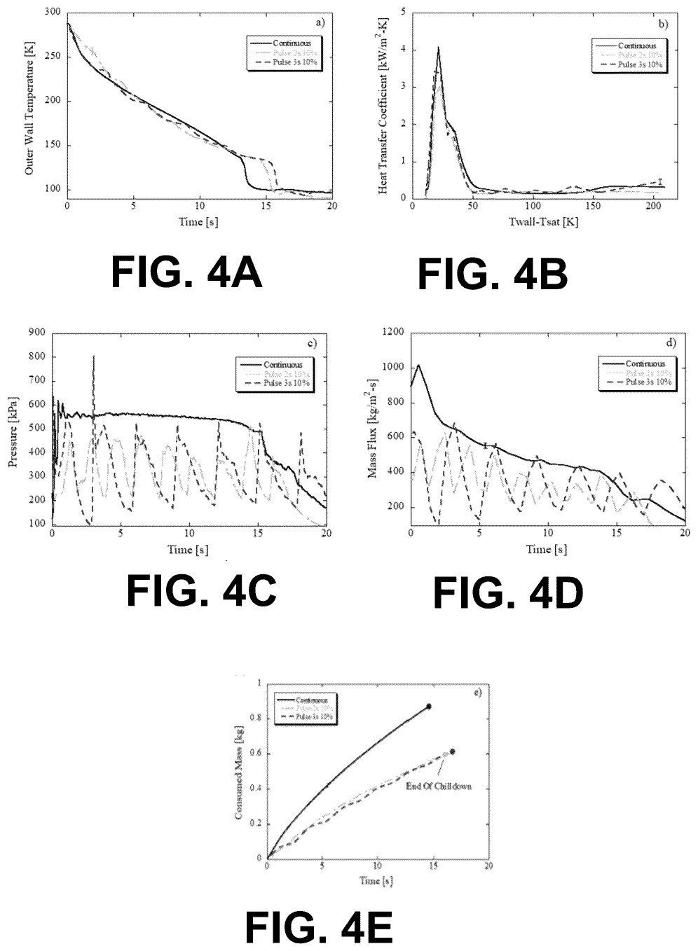

FIG. 4A-4E plot chilldown curves, heat transfer coefficient, pressure, mass flux, and total consumed liquid mass for continuous flow and pulsed flow at a period of 2 s and duty cycle 10% (valve on 0.2 s, valve off 1.8 s) and for period 3 s and duty cycle 10% (valve on 0.3 s, valve off 2.7 s) at higher Re (53859-64092). Trends are as follows: First, both continuous and pulse flow exhibit the same chilldown curve and proceed through the same transition points. For pulse flow, the longer the valve-off time, the more the tube temperature stabilizes as residual cooling due to blowdown diminishes. Second, from FIG. 4A, 4E, it is clear that pulse flow achieves chilldown using less propellant but at the cost of longer chilldown time due to better use of sensible and latent energy of the fluid. FIG. 4C, 4D shows fluctuations in pressure and mass flux that are due to valve cycling, that these fluctuations continue until end of chilldown, and that the fluctuation amplitudes are higher for longer periods. From Table 1 of FIG. 1, there is 29-32% mass savings with pulse flow in comparison to continuous flow at these flight conditions. Third, for a fixed duty cycle, reducing the valve-open time leads to slightly shorter chilldown times (although not shown directly in FIG. 4) and, slightly less propellant consumption as shown in FIG. 4A, 4E; this trend compares well with previous pulse flow tests for both LN2 and LH2. Fourth, for this particular comparison, FIG. 4B shows that continuous flow exhibited a higher CHF over pulse flow, and that reducing the valve open time reduced the CHF. Because of the temperature stabilization when the valve was cycled off, the temperature does not drop as rapidly in pulse compared to continuous flow which caused the wall temperature first derivative term to be lower at CHF in pulse flow. However, if the CHF was traversed when the valve was on, it is expected that the pulse flow heat transfer coefficient (HTC) would be nearly equivalent to that of continuous flow. For bare tubes in microgravity, while higher frequency, shorter pulse widths are favorable from a chilldown efficiency standpoint, more valve cycles implies higher risk of valve degradation and potential failure. Therefore, there is an inherent trade-off in which the optimal valve duty cycle could be determined.

### Performance Gain of Combined Pulsed Flow and Coated Tubes in Microgravity

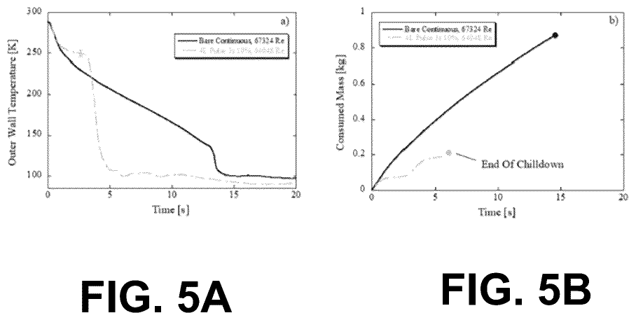

FIG. 5A, 5B plot chilldown curves and total consumed liquid mass for bare tube with continuous flow and 4 L coated tube with pulsed flow characterized by a period of 3 sec and duty cycle of 10% (valve on 0.3 s, valve off 2.7 s) at higher Re (64,048-67,324). Trends are as follows: First, the effect of coating on reducing chilldown time seems to outweigh the effect of pulse flow on increasing chilldown time as evidenced by the sharp drop in temperature at ˜4 s in FIG. 5A for the coated tube. Second, the individual benefits of propellant mass savings with coating and pulse flow are nearly perfectly superimposed, leading to a 76% reduction in propellant consumption. Results thus show that high performance is still achieved in microgravity for pulse flow with a low thermal conductivity coating which leads to a reduction in chilldown time and mass and increase in chilldown efficiency over continuous flow with a bare tube.

### Methods

### Experimental Description

Four successful cryogenic line chilldown parabolic flight campaigns were completed between 2015 and 2020. The fourth-generation system was modified based on flights from the first and second-generation systems. As before, the system is intended for both ground and flight experiments. FIG. 6A shows a system flow network and piping and instrumentation diagram while FIG. 6B shows a picture of the actual flight rig. LN2 was supplied to the system from an 80-liter vacuum jacketed-dewar, with a relief valve set at 861 kPa. A gaseous nitrogen (GN2) cylinder initially pressurized at 15 MPa was used to pressurize the dewar to a set value for each test, which ranged between 90 and 830 kPa absolute pressure. Dewar pressure was managed by a pressure regulator that controlled the dewar pressure to within 35 kPa of the set value during each test. Depressurization was carried out by opening the globe valve 2 (GV2) and the three-way ball valve 1 (3V1) to allow ullage gas to vent to the atmosphere.

The dewar was used to supply the LN2 both for prechilling the plumbing upstream of the test section and for conducting the actual chilldown experiment. LN2 was delivered through valve GV3 that was connected through a 1.2 m long, 1.27 cm outer diameter (OD), 1.18 cm inner diameter (ID) 304 (stainless steel) SS braided hose to the inner tube of the precooler (or subcooler) shell-tube heat exchanger shown in FIG. 5C. The subcooler served three purposes: (1) to preserve subcooling of the liquid from the storage tank flowing through the transfer line by eliminating parasitic heat leak, (2) to slightly subcool the LN2 in the transfer line, since the saturation temperature of the shell side was always lower than the tube side, and most importantly (3) to ensure single-phase liquid at the inlet of the test section. The liquid level of the nitrogen pool was monitored by three thermocouples (TC) inside the subcooler, two at the shell-side and one at the outlet to Vap1. The temperature readings of these TCs were displayed on a laptop in real-time. The level of the LN2 pool was inferred from the TC insertion depth. A 2.5 cm ID port allowed evaporating liquid to escape the subcooler. The fluid was directed to an electrically heated “vaporizer” Vap1 which vaporized any entrained liquid and warmed the vapor to above 273 K before entering the atmosphere. Two layers of 6.35 mm thick aerogel insulation were wrapped around GV2, the hose upstream of the subcooler, the subcooler itself, 3V2, 3V3, and the 3 cm length of tube between 3V3 and the subcooler to minimize heat leak into the system upstream of the test section.

During the prechilling process, the liquid exiting the inner tube of the subcooler was directed by two “T-type” 316SS 1.27 cm ID three-way ball valves (3V3 and 3V2) to a fill-port on top of the outer vessel of the subcooler. A 3 cm long, 1.270 cm OD, and 1.168 cm ID 304SS tube connected 3V3 to the subcooler. A pressure transducer and TC labeled “PT”, “TC” in FIG. 6A were placed between a solenoid valve (SV) and a three-way vale (3V2) at a distance of 7 cm from the downstream side of the inner tube of the subcooler to measure the fluid pressure and fluid temperature. This station was also used to determine the thermodynamic state of the fluid at the inlet of the test section.

Once the flow inlet temperature reached a steady value, and that steady temperature was below the saturation temperature based on the measured pressure, a chilldown test was ready to commence. As shown in FIG. 6A, the test section was enclosed in the vacuum chamber and sealed by two flanges (D and E). A 316SS vacuum chamber was used to reduce radiation and gas conduction parasitic heat leak to the test section from the surroundings, which reduces the uncertainty in the calculation of wall-to-fluid heat flux. A mechanical pump reduced background pressure to ˜1 Pa. The needle valve downstream of the test section (NV1) was used to provide fine-tuning of the mass flow rate so that tests could be run at different flow rates for the same dewar pressure setting. The flow was routed from the needle valve by a SS tube to two separate vaporizers (labeled Vap2 and Vap3) that were electrically heated to vaporize the liquid-vapor two-phase flow. To enhance the heat transfer in the vaporizer, eight 1.27 cm OD copper tubes were packed inside the vaporizer in an octaweb configuration. One electrical heating tape was wrapped around the vaporizer to heat it to 550 K before each test. A TC was placed on the outer surface of each heating tape to monitor the temperature in real time. The flow out of Vap2 and Vap3 entered two separate, identical gas flow meters (Gas Flow Meters 1 and 2) that each had a capacity of 3000 standard liters per minute. The flow was then directed to the airplane vent ports downstream the flow meters.

### Test Sections

Three, 0.914 m (36 in) long, 0.051 cm wall thickness, 1.27 cm outer diameter SS304 test sections were individually flight tested: a bare tube with no coating, and a tube with a 4 layer and 7 layer coating. For the coated tubes, the SS tube was coated with low-thermal conductivity thin Teflon layers on the inner surface. Specifically, the coating material was made of Fluorinated Ethylene Propylene (FEP) produced by DuPont and classified by DuPont as Teflon 959G-203 that is a black color paint. In some examples, the coating was applied by using a pour and drain process. After each pour and drain, the fresh film layer was cured in a furnace through a standard sintering procedure before adding another layer by the same pour and drain procedure.

As a result, the final thickness of the coated layer depends on the total number of layers processed; for example, the 4 L coating went through the pour and drain process four separate times. To measure the coating layer thickness, high resolution computer tomography x-ray scans of the tube cross sections were obtained using a Phoenix v|tome|x M system in the Nano Research Facility at the University of Florida. Scanning was carried out using a 240 kV X-ray tube and a tungsten-on-beryllium target, with the following settings: 200 kV, 50 milliamps, and 0.5 mm Tin filter. Images were collected from 1600 pixels horizontal, 2024 pixels vertical, 0.5 s detector exposure, averaging of 4 images per rotation position with a one-exposure skip and a total of 2200 rotational positions. The average thickness per layer was ˜15.12 μm and the uncertainty for each layer was ±0.7 μm.

### Instrumentation and Data Acquisition

Virtual Instrument software and National Instrument (NI) Compact DAQ hardware was used to collect all sensor data to be displayed in real-time on a laptop. The sampling rate of all the sensor measurements was set to 16 Hz. Two NI-9214 TC modules read the signals from all the T-type TCs. NI 9205, an analog input module, read all the voltage signals from pressure transducers. The Labview VI controlled the opening and closing of the solenoidal valves (SVs), through a combination of NI-USB 6009 and Solid-State relay. In the case of continuous flow, the relay energized the solenoid valve after receiving a constant voltage signal. For pulse flow, the relay energized and de-energized SV according to a rectangular waveform voltage signal generated by the Labview VI. Signals of the two mass flow meters (Alicat M3000-SLPM) downstream of the vaporizers were read by the program directly without the NI DAQ system. Fifteen TCs were soldered to the outside of each tested tube. Five stations were spaced out axially in FIG. 6D and three TCs were spaced out radially 90° (top, bottom, side) at each station as shown in FIG. 6E. Two cryogenic rated PTs were placed near the inlet and after the outlet of the test section by yor-lok fittings, respectively to provide the transient pressure histories at the two locations. The rest of the instrumentation is shown in FIG. 6A.

### Uncertainty Analysis

Root-sum-square uncertainty analysis was conducted; uncertainties for test section dimensions, vacuum chamber dimensions, and thermal properties as prior tests. Standard error propagation rules were applied to compute uncertainties in chilldown time (2.1%), propellant mass consumed at steady state (2.5%), mass flux (2.8%), and Re number (3.3%). The median relative uncertainties were 8-10% in Burggraf heat flux, total heat flux, and HTC, and 25% in parasitics across all the bare tube cases. The number of outliers in relative uncertainties were on the order of 101 or fewer in each case and occurred post-chilldown. Therefore, the 95% quantile accurately represents the maximum relative uncertainties in Burgraff heat flux, parasitics, total heat flux, and HTC which are reported in Table 1 of FIG. 1 and depicted as error bars in plots.

### Experimental Methodology

The experimental methodology to conduct a test was as follows: At the start, the needle valve was set to the target position to set test section pressure, Vap 1, Vap2, and Vap3 were heated up to 550 K, and the vacuum pump system was turned on. The total time from engaging the pump until reaching 1 Pa inside the vacuum chamber was ˜15 min. Concurrently, the inner tube inside the subcooler was chilled by pressurizing the dewar, opening GV2, and directing the flow through 3V3 and 3V2 to the fill port of the subcooler. The subcooler took ˜10 min to completely chill and fill. Then, 3V2 was shut off to stop the flow from 3V3, and the supply dewar was pressurized by opening the pressure regulator to the desired gauge pressure for the dewar.

Pressurization was done as quickly as possible before the liquid inside the dewar could re-saturate at the new dewar pressure, and also before the liquid inside the plumbing upstream of the test section could gain enough heat to start boiling. Shortly after, 3V3 was turned to start the flow into the test section to begin a chilldown test. Once the TC readings dropped below the saturation temperature and maintained a steady temperature, GV2 and SV was closed. This marked the end of the test. In preparation for the next test, Heater 1 was turned on, and both 3V2 and 3V3 were rearranged so that warm gas could enter the test section to carry out the reheat process. After reheating was finished, NV1 was set at the new position. Vap2 and Vap3 were allowed to heat up to above 550 K, and the subcooling process was repeated to account for the lost LN2. At this time, the system is ready for another run.

### DISCUSSION

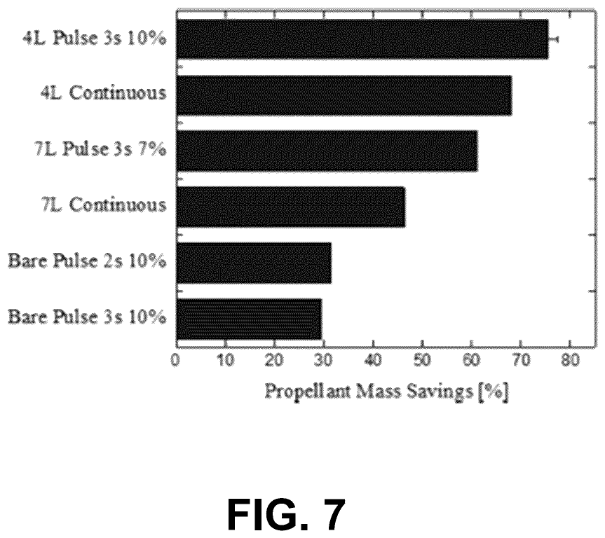

FIG. 7 summarizes results in terms of mass savings for the cases discussed previously. Overall, pulse flow through a coated tube significantly outperforms continuous flow through a bare tube at any flow rate under microgravity. The combined case of pulse flow and coated tube also outweighs the performance gains of just coated tube or pulse flow. Across a wide range of Reynolds numbers, results show that the combination significantly enhance performance, with a reduction in consumed mass up to 75% relative to continuous flow for a bare transfer line. Surprisingly, when compared to 1-g coated tube pulse flow tests from other studies, at somewhat similar inlet pressure, period, and duty cycle, the mass savings in going from continuous flow with a bare tube to pulse flow with a coated tube is slightly higher in microgravity (˜75%) versus in 1-g (67%) at similar high Re. The lower mass savings in 1-g can easily be attributed to the fact that the duty cycle of the 1-g coated tube pulse flow test is 20% compared to 10% of 0-g coated tube pulse flow test in the current work. Lower duty cycle is predicted to increase mass savings which means that a 1-g coated tube pulse flow test performed at 10% duty cycle would have >67% propellant mass savings. At high Re, the mass savings would be roughly equal in microgravity and 1-g because of forced convection dominating over buoyancy effects. However, at low Re, 1-g results would be expected to yield higher mass savings due to the aforementioned lack of buoyancy-assisted cooling in microgravity at low Re, whether comparing 1-g pulse flow to 0-g pulse flow or 1-g coated tube flow to 1-g coated tube flow. Therefore, with optimization of coating thickness and pulse characteristics performed a priori, coated tube and pulse flow can be used for transfer line chilldown to significantly save chilldown time and mass for all future in-space cryogenic transfers.

The present disclosure describes various embodiments for these issues. Based on transient heat transfer between a surface and a flow, the rate of heat transfer at the interface between the tube and the coolant flow would always spike up when the tube surface experiences a fresh coolant impact after the intermittent pulse flow is turned on in a duty cycle. The above is the basic physics explaining why the pulse flow would produce higher heat transfer rates as compared to the continuous flow. The quenching heat transfer enhancement by flow pulsing has been reported for terrestrial applications, but no one has verified the enhancement in microgravity.

However, the tube coating acts as an insulator between the cold propellant and warm wall, resulting in an inner wall surface temperature that reaches the Leidenfrost point much faster than the bare inner surface pipe without cooling the entire pipe mass. The coating allows the inner surface to chill down much faster relative to the uncoated line because liquid comes in contact sooner. This results in substantially shortening of the film boiling period that facilitates a much shorter chilldown process. Recent 1-g experiments conducted in the United States and China independently confirmed that a Teflon coated tube could reduce chilldown times up to 75% over an uncoated stainless steel (SS) tube using LN2. It was not clear if this same performance would hold in microgravity. In reduced gravity, it is even harder to disrupt the vapor layer due to the lack of buoyancy forces. Parabolic flight tests onboard a Zero-G aircraft were recently conducted and proved that the performance gain in 1-g does hold in microgravity. This may revolutionize cryogenic propellant transfer in reduced gravity and microgravity.

The embodiments of the present disclosure related to a coated tube with flow pulsing towards cryogenic propellant transfer in a microgravity environment. The coating with flow pulsing reduces the amount of consumed mass by up to 75% in a microgravity environment as is evident in the data that was collected. The flow pulsing intermittently refreshes the tube surface that substantially increases the heat transfer. For coating, the benefit arises from the anisotropic material properties created by the metallic transfer line structure and the low-conductivity internal coating, restricting heat flow through the coating but allowing it much more freely through the metal. The low conductivity coating expedites the arrival of Leidenfrost point on the coating surface that facilitates the wetting of the surface by liquid cryogen. As a result, the liquid that enables much higher heat transfer can reach the wall much sooner than without the coating.

In some embodiments, a cryogenic propellant transfer apparatus for microgravity can include a metallic pipe for transferring cryogenic propellant from a fuel storage tank to a first nozzle of a combustion chamber for a rocket engine. An inner surface of the metallic pipe can include a thermal insulator layer. The apparatus can further include a feed system that is configured to use a pulse flow for transferring the cryogenic propellent from the fuel storage to the first nozzle of the combustion chamber for the rocket engine through metallic pipe. The feed system can include an intermittent pump for performing the pulse flow.

Additionally, the cryogenic propellant transfer apparatus can further include a second metallic pipe for transferring liquid oxygen from an oxidizer to a second nozzle of the combustion chamber for the rocket engine. The second metallic pipe can have a second thermal insulator layer as an inner surface. The first and second thermal insulator layers can have a thermal conductivity in a range of 0.1 Watt per meter-Kelvin to 1.0 Watt per meter-Kelvin. In some examples, the preferred thermal conductivity can be about 0.25 Watt per meter-Kelvin.

The first and second thermal insulator layers can include the use of polytetrafluoroethylene or Teflon™. The first and second thermal insulator layers can have a thickness in a range from 20 micrometers to 100 micrometers. In some examples, the preferred thickness is about 70-80 micrometers.

The feed system can be configured to execute the pulse flow with a duty cycle of less than 20% for a valve on in the feed system. In some examples, the preferred duty cycle is about 10% for a solenoid valve in the feed system.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A cryogenic propellant transfer apparatus for a chilldown process in microgravity, comprising:
a metallic pipe for transferring cryogenic propellant fuel from a fuel storage tank to a nozzle of a combustion chamber for a rocket engine;
an inner surface of the metallic pipe comprising a low thermal conductivity thin-filmed coating layer, wherein the low conductivity thin-filmed coating layer has a thermal conductivity in a range of 0.1 Watt per meter-Kelvin to 1.0 Watt per meter-Kelvin; and
a feed system that is configured to use a pulse flow for transferring the cryogenic propellent fuel from the fuel storage tank to the nozzle of the combustion chamber for the rocket engine through the metallic pipe.

2. The apparatus of claim 1, wherein the nozzle is a first nozzle for transferring the cryogenic propellent fuel, the metallic pipe is a first metallic pipe, and the apparatus further comprising:
a second metallic pipe for transferring liquid oxygen from an oxidizer storage tank to a second nozzle of the combustion chamber for the rocket engine.

3. The apparatus of claim 1, wherein the low thermal conductivity thin-filmed coating layer comprises polytetrafluoroethylene.

4. The apparatus of claim 1, wherein the low thermal conductivity thin-filmed coating layer has a thickness in a range from 20 micrometers to 100 micrometers.

5. The apparatus of claim 1, wherein the feed system is configured to execute the pulse flow with a duty cycle of less than 20% by a solenoid valve in the feed system.

6. The apparatus of claim 1, wherein the fuel storage tank is an Earth-orbiting propellant storage vessel.

7. The apparatus of claim 1, further comprises:
a temperature sensor that is configured to measure a temperature of the metallic transfer pipe.

8. The apparatus of claim 7, wherein the feed system is configured to terminating the pulse flow and the chilldown process upon the temperature of the metallic transfer pipe meeting a liquid propellant temperature.

9. The apparatus of claim 7, wherein the temperature sensor measures an outer wall location of the metallic pipe.

10. The apparatus of claim 1, wherein the pulse flow is generated using an inlet valve to cyclically open and close based at least in part on a duty cycle.

11. A method of performing a chilldown process in a transfer pipe in microgravity, comprising:
determining, via a temperature sensor, a temperature of a metallic transfer pipe for a chilldown process, the metallic transfer pipe being configured to transfer liquid propellant from a propellant storage to a nozzle of a combustion chamber of a rocket engine, the transfer pipe comprising a low conductivity thin-filmed coating layer as an inner surface, wherein the low conductivity thin-filmed coating layer has a thermal conductivity in a range of 0.1 Watt per meter-Kelvin to 1.0 Watt per meter-Kelvin;
pulse flowing, via a duty cycle for a valve, the liquid propellent from the propellant storage to the nozzle of the combustion chamber for the rocket engine through metallic transfer pipe; and
terminating the pulse flow and the chilldown process upon the temperature of the metallic transfer pipe meeting a liquid propellant temperature.

12. The method of claim 11, wherein the nozzle is a first nozzle for transferring the cryogenic propellent fuel, the metallic transfer pipe is a first metallic transfer pipe, and the method further comprising:
transferring liquid oxygen, via a second metallic pipe, from an oxidizer storage tank to a second nozzle of the combustion chamber for the rocket engine.

13. The method of claim 11, wherein the low thermal conductivity thin-filmed coating layer comprises polytetrafluoroethylene.

14. The method of claim 11, wherein the low thermal conductivity thin-filmed coating layer has a thickness in a range from 20 micrometers to 100 micrometers.

15. The method of claim 11 wherein the duty cycle is executed with the duty cycle less than 20% by the valve in a feed system.

16. The method of claim 11, wherein the propellant storage an Earth-orbiting propellant storage vessel.

17. The method of claim 11, wherein the temperature sensor is a thermocouple.

18. The method of claim 11, wherein the temperature sensor measures an outer wall location of the metallic transfer pipe.

19. The method of claim 11, wherein the value is an inlet valve, and the pulse flow is generated using the inlet valve to cyclically open and close based at least in part on the duty cycle.

20. The method of claim 11, wherein the pulse flowing is performed in the microgravity environment.
